(19) United States
(12) Patent Application Publication
(10) Pub. No.: US 2017/0108042 A1
(43) Pub. Date: Apr. 20, 2017

(54) STACK BEARING WITH CARBONITRIDED BEARING BALLS

(71) Applicant: Schaeffler Technologies AG & Co. KG, Herzogenaurach (DE)

(72) Inventor: Shawn Pierce, Fort Mill, SC (US)

(73) Assignee: Schaeffler Technologies AG & Co. KG, Herzogenaurach (DE)

(21) Appl. No.: 14/884,048

(22) Filed: Oct. 15, 2015

(51) Int. Cl. F16C 33/32; F16C 19/18

(52) U.S. Cl. CPC F16C 33/32; F16C 19/18; F16C 2204/70; F16C 2204/66; F16C 2223/16

(57) ABSTRACT

A stack bearing assembly is provided having stacked bearing rings and bearing balls located between the rings in races. The bearing balls are formed from 100Cr6 steel that is carbonitrided. After carbonitriding, the bearing balls are polished. The carbonitrided and polished bearing balls are assembled in the races of the bearing rings to provide increased resistance to wear from the debris traveling through the bearing assembly in use, and increase toughness in order to withstand the wear caused by debris in a drilling rig. A method of producing a stack bearing assembly is also provided.

### FIELD OF INVENTION

The present invention relates to a bearing assembly, and is more particularly related to a stack bearing assembly.

### BACKGROUND

Bearing assemblies are used in a variety of applications, including large-scale drilling applications. Drilling applications require support bearings, typically in the form of a stack bearing assembly. Stack bearing assemblies are comprised of a plurality of bearing assemblies, which are stacked adjacent to each other to methodically and consecutively distribute the loads experienced by stack bearing assembly among the individual bearings.

During drilling, pressurized medium is provided to a well to flush debris from the well. As the debris exits the well, the debris travels through the rolling surfaces of the stack bearing assembly which erodes and damages the bearing components. The debris lowers the life cycle of the bearing in comparison to other applications and requires the bearing components to be replaced more often than such other bearing applications. Replacement of the bearings is expensive and time consuming. The debris can also cause the bearing to be less efficient and can also cause premature component failure.

Known bearing balls for stack bearings used in drilling applications are formed from 100Cr6 martensitic bearing steel (S2 or SAE 52100). Bearing life is usually determined by failure of the bearing balls which are typically the first component to fail. It would be desirable to increase the bearing life in stack bearings to provide further resistance to the damage caused by the debris traveling through the bearing assembly.

### SUMMARY

A stack bearing assembly with stacked bearing rings and bearing balls located in races therein is provided. The bearing balls are formed from 100Cr6 steel that is carbonitrided. After carbonitriding, the bearing balls are polished. The carbonitrided and polished bearing balls are assembled in the races of the bearing rings to provide increased resistance to wear from the debris traveling through the bearing assembly in use, and increased toughness in order to withstand the wear caused by debris in a drilling rig.

A method of producing a stack bearing assembly is also provided, including: forming bearing balls from 100Cr6 steel, carbonitriding the bearing ball, polishing the carbonitrided bearing balls, and assembling the bearing balls between inner and outer races of at least one rolling bearing.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a perspective view of the stacked bearing assembly.

FIG. 2 is a cross-sectional view of a stacked bearing assembly.

FIG. 3 is a bar graph showing the life factor for a bearing component formed from 100Cr6 martensitic steel and a bearing component formed from 100Cr6 carbonitrided steel.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft or rotating part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

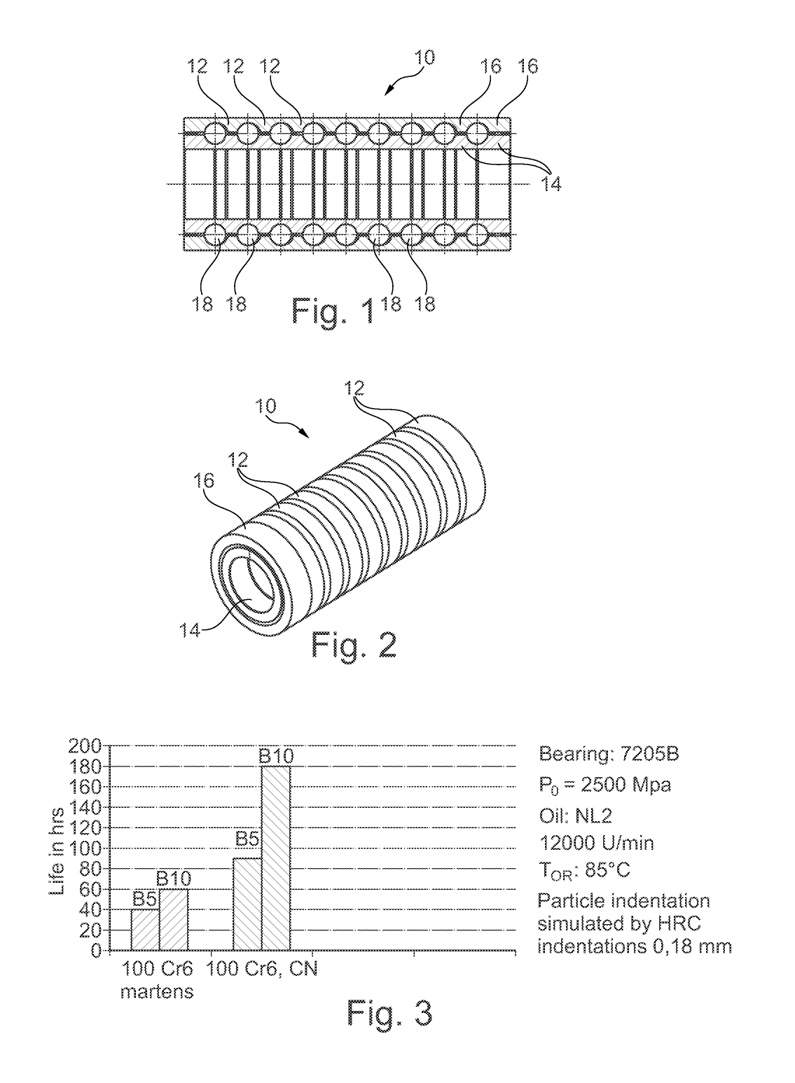

FIGS. 1 and 2 illustrate a stack bearing assembly 10 including a plurality of rolling bearings 12, the size and number of which can be varied depending on the particular application. The rolling bearings 12 each include inner and outer bearing rings 14, 16 formed of a bearing grade steel. Bearing balls 18 are located in the races on the inner and outer bearing rings 14, 16. The bearing balls are made of 100Cr6 bearing grade steel, and are preferably punched or forged to a near net shape, ground, hardened, finish ground and polished. The bearing balls 18 are carbonitrided after hardening or finish grinding in order to increase surface hardness. The carbonitriding is preferably to a surface depth of about 50 μm. The bearing balls are polished, preferably using abrasive particles or an abrasive slurry, to achieve a desired surface roughness. This can be, for example in the range of 0.2-0.02 μm. Depending on the timing of the carbonitriding, the finish grinding and/or polishing reduces the carbonitrided surface layer thickness, but it is still in the range of approximately 20 μm or greater.

FIG. 3 illustrates a bar graph showing the life expectancy for a stack bearing assembly with a 100Cr6 martensitic steel bearing component in comparison to the stack bearing assembly 10 with 100Cr6 steel bearing component that is carbonitrided. As shown in FIG. 3, B5 refers to when 5% of a tested part statistically fails and B10 refers to when 10% of a tested part statistically fails. The B5 value of the stack bearing assembly 10 with the 100Cr6 steel carbonitrided bearing component shows a life expectancy of 90 hours, in comparison to 40 hours for a stack bearing assembly with the 100Cr6 martensitic steel bearing component. The B10 value of the stack bearing assembly 10 with the 100Cr6 steel carbonitrided bearing component shows a life expectancy of 180 hours, in comparison to 60 hours for a stack bearing assembly with the 100Cr6 martensitic steel bearing component. This shows the life expectancy increase for 100Cr6 martensitic steel bearing components in the stack bearing environment, and it is believed that similar increases would be seen with respect the bearing balls 18 according to the invention to the extent that the bearing balls in a stack bearing are the weak link with respect to life expectancy in comparison to the inner and outer rings.

The use of the stack bearing assembly 10 with rolling bearings 12a-e having 100Cr6 bearing grade steel bearing balls 18 that are carbonitrided provides for an estimated two-fold or more increase bearing life for the stack bearing assembly 10.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A stack bearing assembly, comprising:
a plurality of bearing assemblies including inner and outer rings having races; and
a plurality of bearing balls located between the inner and outer rings in the races, the bearing balls are formed of 100Cr6 steel that is carbonitrided.

2. The stack bearing assembly of claim 1, wherein the bearing balls that are carbonitrided are polished to have a surface roughness in a range of 0.2-0.02 μm.

3. The stack bearing assembly of claim 1, wherein the carbonitrided surface layer has a thickness of 20 μm or greater.

4. A method of producing a stack bearing assembly, comprising:
forming bearing balls from 100Cr6 steel;
carbonitriding the bearing balls;
polishing the carbonitrided bearing balls; and
assembling the bearing balls between inner and outer races of at least one rolling bearing.
